(19) United States
(12) Patent Application Publication
(10) Pub. No.: US 2004/0124083 A1
(43) Pub. Date: Jul. 1, 2004

(54) Device and method for casting multiple gels of electrophoresis

(76) Inventor: Sephen L. Chen, Beaverton, OR (US)

Correspondence Address: Stephen L. Chen, 18510 SW Honey wood Dr, Beaverton, OR, 97006, US

(21) Appl. No.: 10/334,636

(22) Filed: Dec. 31, 2002

(51) Int. Cl. G01N 27/26

(52) U.S. Cl. 204/470; 204/619

(57) ABSTRACT

A device and a method for casting 50 gels at once in a single gel mold are provided. Gel solution is poured into a single gel mold, solidified into a gel block, and served as monthly gel supply of electrophoresis. For each application, a gel piece is easily sliced off from the gel block and ready for sample loading.

### FIELD OF THE INVENTION

The present invention relates in general to devices and methods of gel electrophoresis, and in particular, to multiple gel preparation.

### BACKGROUND OF THE INVENTION

Gel electrophoresis is one of the most frequently utilized tools for biomedical researches and industries. In gel electrophoresis, samples are loaded into a plurality of sample wells in a gel matrix. Charged molecules in loaded samples then migrate from sample wells into gel matrix when electric field being applied. Different molecules migrate in different rate and appear as distinguishable bands in gel matrix.

By placement of gel matrix, gel devices and methods can be classified into two types, vertical gel electrophoresis and horizontal gel electrophoresis. For easy gel matrix formation, sample wells of gel matrix in the two types are usually constructed differently. Vertical gel has openings from top edge while the later from planar surface. The first operation of gel electrophoresis is gel matrix formation. It takes 3 steps to prepare a single gel matrix. Step one is gel mold setup. Step two is gel solution preparation. And step three is waiting for solidification of gel solution into gel matrix. This 3-step procedure will be required for next run of gel electrophoresis because gel matrix is usually prepared individually in laboratories. The development of modern biotechnology requires projects being conducted in fast working pace within a limited time frame. Gel electrophoresis in time saving high efficiency manner is critical and highly desired. Numerous attempts have been made. Chen in U.S. Pat. No. 5,549,806 enhances efficiency by means of faster sample migration in gel matrix under higher voltage. But Chen, while achieving certain progress, fails to save time in gel casting period. Chen's device requires gel preparation individually each time when running gel electrophoresis. Anderson et al. in U.S. Pat. No. 4,169,036 teaches a device to pour multiple gels for vertical electrophoresis. But Anderson et al. fails to provide a simple way for multiple gel casting. His device requires a series of steps to assembly holders and other parts into gel mold before gel casting and a long time to clean up those parts after that. Anderson et al. further fails to use his gel for horizontal electrophoresis because sample wells are opened from top edge of gel matrix within each slab gel holder. Kirkpatrick et al. in U.S. Pat. No. 5,443,704 provides a gel container to hold commercially made pre-cast gel so that horizontal electrophoresis can be run without individual gel casting. But the majority of laboratories are prevented from accepting it in daily experiments due to its high costs, poor quality of performance, and limited gel format. Kirkpatrick et al. further fails to provide a device for researchers to pour their own multiple gels in laboratories.

A simple device and method for casting multiple gels by researchers in laboratories is highly desired but remain unsolved.

### SUMMARY OF THE INVENTION

It is, therefore, an object of the invention to provide a simplified device and method to cast multiple gels by researchers in laboratories for either vertical or horizontal gel electrophoresis. The advantages of the device and method are:

(1) It saves time. Electrophoresis can be performed without casting a gel matrix individually.

(2) It is simple. Multiple gels are poured and stored in a single gel mold.

(3) It is affordable. Low cost feature enables the majority of researchers to cast their own multiple gels in laboratories.

### BRIEF DESCRIPTION OF THE DRAWINGS

FIG. 1 shows a perspective view of a first embodiment of the invention.

FIG. 2a is a side view of the first embodiment including poured gel solution inside.

FIG. 2b illustrates how a gel piece is generated from solidified gel block via slicing in 45° angle.

FIG. 3a is an illustrative diagram revealing the principle of sample well formation.

FIG. 3b is a side view of a gel piece placed in electrophoresis chamber.

FIG. 4a and 4b introduces one option of knife and guiding tool for gel slicing.

FIG. 4c demonstrates the cooperation of the guiding tool with the gel block.

FIG. 5a and 5b illustrates a second embodiment of the invention.

### DETAILED DESCRIPTION OF THE INVENTION

For horizontal electrophoresis, it is highly desirable to pour multiple agarose gels at once and then use them for a month. One option of pouring 50 gels could be as follows:

1. Setup 50 gel molds for holding gel solution.

2. Install 50 combs to each gel mold for forming sample wells.

3. Measure volume of gel solution 50 times.

4. Pour measured gel solution 50 times into each gel mold.

5. Seal each gel mold for storage. And,

6. Clean up and store all those molds and combs after use.

In current practice, agarose gels are still poured individually rather than 50 gels at once because its inconvenience is much greater than its achievement. Besides, it is an unnecessary burden to purchase 50 sets of the devices for most of laboratories.

The essential idea of the invention is to cast up to 50 gels at once in a single gel mold.

The key feature of the invention is to solidify gel solution into a single gel block. Gel pieces can be then sliced off from the gel block for electrophoresis.

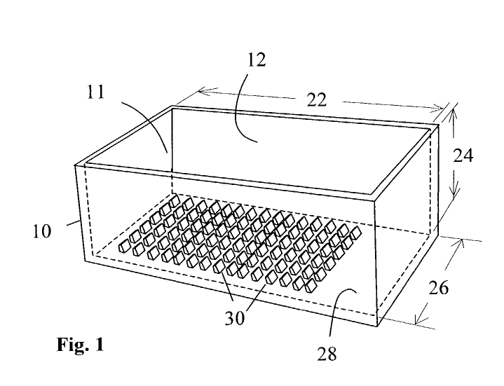

FIG. 1 is a perspective view of a first embodiment of the invention. A liquid container 10, accessible from its open top, is constructed with a bottom 28 and wall 12 in rectangular shape. A plurality of teeth 30 forms multiple parallel rows. One row of teeth 30 will form one row of sample wells of a gel matrix. For example, FIG. 1 shows 6 teeth in a row and 15 rows in parallel at bottom 28. Such teeth arrangement allows container 10 to form 15 gels at once. Each gel has 6 sample wells. All rows are parallel from each other and evenly distributed. Teeth 30 extrude from bottom 28 toward internal space 11. The preferred material of container 10, as well as teeth 30, is a rigid and liquid-impermeable plastic, such as polycarbonate or acrylic. Container 10 is used as a gel mold so that its dimensions should be designed by application purpose of the gels formed inside. Container width 26 determines gel width, container height 24 determines gel length, and container length 22 determines gel thickness and how many gels to be generated. For example, to pour 15 gels in size of 6 cm gel length, 10 cm gel width, and 0.6 cm gel thickness, the parameters of container 10 will be about 10 cm in container width 26, 4.5 cm in container height 24, and 17 cm in container length 22.

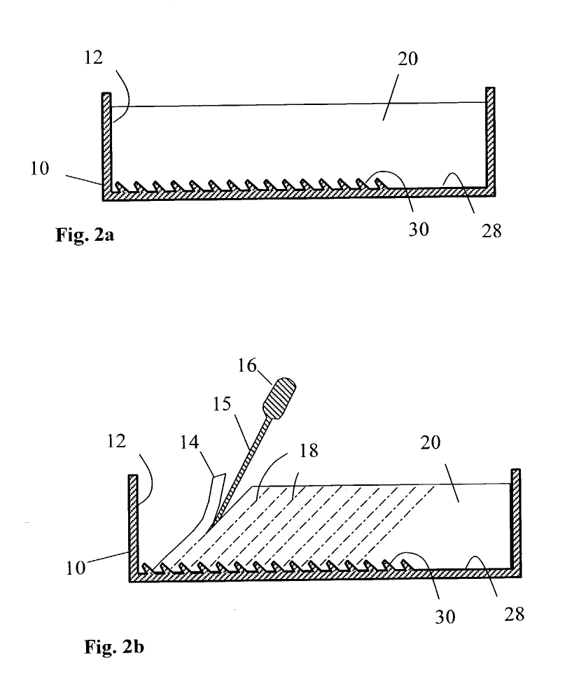

FIGS. 2a and 2b outline the formation of multiple agarose gels. FIG. 2a is a side view of container 10. Agarose gel block 20 is formed in container 10 after temperature reduction of agarose gel solution. Teeth 30 are immersed in gel solution to form sample wells at bottom side of gel block 20. To generate a gel piece 14 for horizontal submarine gel electrophoresis, gel block 20 is sliced by knife 15 in 45° angle from top to bottom, as shown in FIG. 2b. Next gel piece will be sliced along dotted lines 18. More gel pieces can be sliced in the same way through the end of gel block 20.

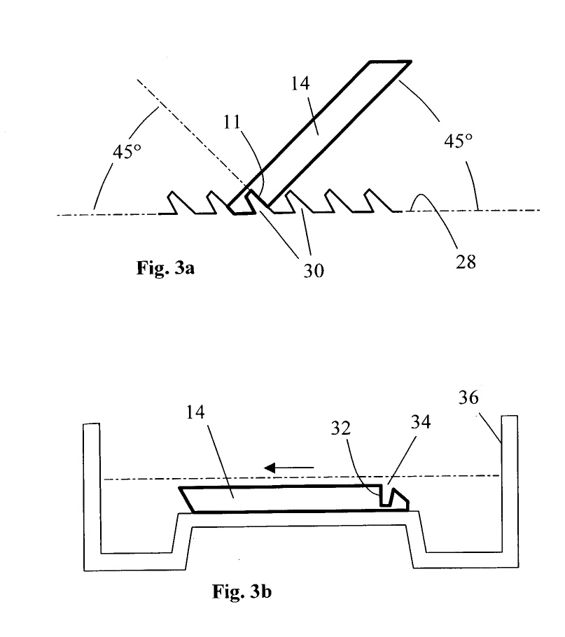

FIG. 3a is an illustrative diagram. Teeth 30 should be constructed in different angles according to different gel formats. For vertical gels, teeth 30 should be vertical on bottom 28. But in this embodiment for horizontal gels, teeth 30 are tilted 45° towards one side, as shown in FIG. 3a. Remember that gel block 20 is sliced in 45° angle towards another side. As a result, a front face 11 of teeth 30 is now 90° perpendicularly formed in gel piece 14. This 90° arrangement is critical. It will generate a vertical front wall 32 of sample wells 34 when gel piece 14 being placed horizontally in electrophoresis chamber 36, as shown in FIG. 3b. Sample wells 34 are now accessible from top for sample loading, the same way as all other traditional agarose gels.

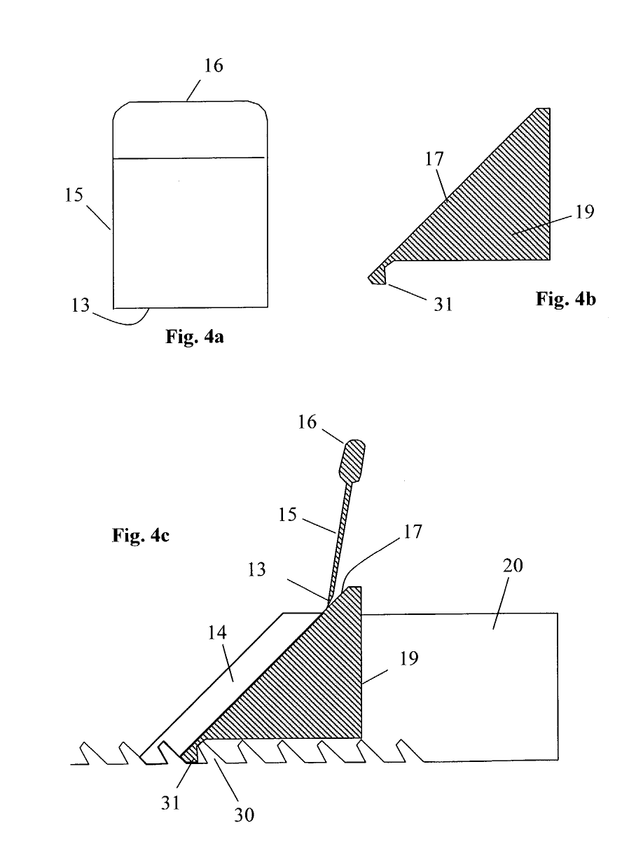

FIGS. 4a, 4b, and 4c introduce cutting tools of the first embodiment. To generate gel pieces, knife 15 is used to cut gel block 20 into slices. Knife 15 is a hand-held stainless sheet having a sharp cutting edge 13 and a handle 16. The width of cutting edge 13 should be compatible with width of gel block 20 but slightly smaller than container width 26 in FIG. 1 so that gel block 20 can be sliced inside container 10. To make gel slicing easy and reliable, a guiding tool 19 is utilized in the system. Guiding tool 19 controls cutting point and cutting angle of gel block 20. There are numerous ways to design guiding tool 19. Basically, it should have a guiding line 17 to control cutting angle and a marker 31 to identify cutting point. The correct cutting point should be set to a position where only one row of sample wells is included in one gel slice. In this embodiment, guiding tool 19 is made with two pieces of stainless sheet. They can be inserted between gel block 20 and container 10 from both sides of gel block 20. Marker 31 contacts teeth 30 to set cutting point, as shown in FIG. 4c. Knife 15 is then pushed down along guiding line 17 to generate gel piece 14.

The operation of the first embodiment is as follows:

1. Prepare agarose gel solution in a suitable volume.

2. Pour agarose gel solution into container 10 and wait for formation of gel block via temperature reduction.

3. Insert guiding tool 19 from both sides of gel block 20 to set a correct cutting point.

4. Push knife 15 along guiding line 17 down in 45° angle to generate gel piece 14 from gel block 20.

5. Move guiding tool 19 to next position.

6. Push knife 15 down again along guiding line 17 to slice gel block 20 into a second gel piece.

7. Repeat steps 5 and 6 until reaching the end of gel block 20.

Gel block 20 can be used as a monthly gel supply of submarine electrophoresis. To prevent moisture loss of gel block 20, container 10 can be easily sealed using a piece of plastic wrap or an airtight cover. For easy placement in laboratories, container length 22 should be less than 50 cm, which is enough to generate about 50 gels at once.

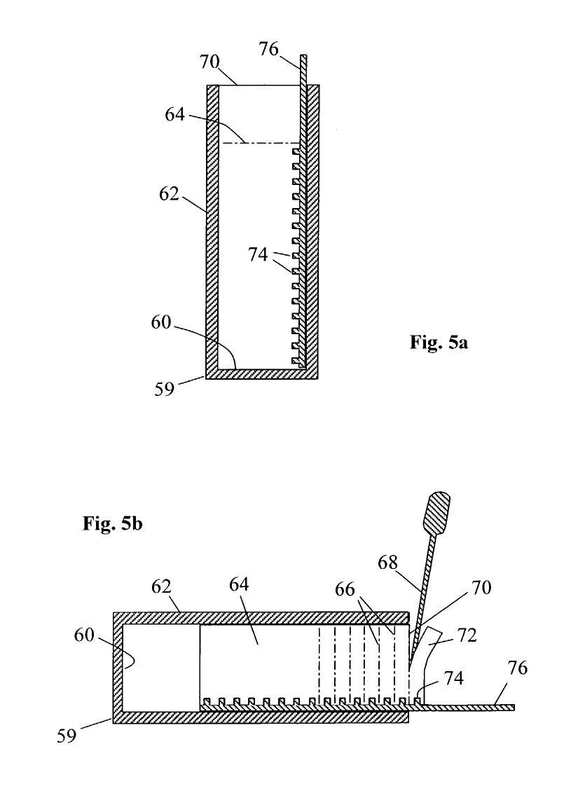

FIGS. 5a and 5b illustrate a second embodiment of the invention. Container 59 has a bottom 60, wall 62, and open edge 70. Teeth 74 are constructed on a plate 76 instead of container bottom 60. Plate 76 is removable from container 59. After solidification of gel solution, gel block 64 is tightly anchored onto plate 76. When need to perform vertical electrophoresis, board 76 is pulled out from container 59 to a position where only one row of teeth 74 being exposed outside edge 70 of container 59. A knife 68 is used to slice gel block 64 along edge 70 to generate gel piece 72. The remaining portion of gel block 64, together with plate 76, can be moved back and stored in container 59. Guiding tool is omitted in this embodiment because teeth 74 can be utilized to determine cutting point and edge 70 can be used as guiding line.

Although the description above contains specifications, it will apparent to whose skilled in the art that a number of other variations and modifications may be made in this invention without departing from its spirit and scope. Teeth 30, for example, can be removable from bottom 28, wall 12 can be constructed in 45° angle with bottom 28 instead of rectangular shape, gel block 20 can be removed from container 10 and then sliced using different guiding tools for slicing. Thus, the description as set out above should not be constructed as limiting the scope of the invention but as merely providing illustration of the presently preferred embodiment of the invention.

What is claimed is:

1. A device for casting multiple gels used in electrophoresis, comprising:
a container, made with liquid impermeable material, constructed with a bottom, an opening, and walls in a configuration determined by dimensions of said multiple gels, having an interior space to hold liquid;
a plurality of teeth, made with solid material, arranged in a pattern of multiple parallel rows, extruded towards said interior space, forming multiple rows of sample wells of said multiple gels;
a gel solution, composed of water, gelling material, and buffering chemicals at a desired concentration, held by said container, occupying said interior space, contacting said plurality of teeth, being capable of solidifying as a gel block;
a guiding means, having a guiding line for cutting path control and a marker for position control, determining cutting point and cutting angle of said gel block;
a slicing means, having a cutting edge compatible to said gel block, guided by said guiding means, slicing said gel block to generate multiple gels.

2. The device as claimed in claim 1 wherein said gelling material is agarose.

3. A method for casting multiple gels used in electrophoresis, comprising:
(a) providing a device for casting multiple gels, having:
a container, made with liquid impermeable material, constructed with a bottom, an opening, and walls in a configuration determined by dimensions of said multiple gels, having an interior space to hold liquid;
a plurality of teeth, made with solid material, arranged in a pattern of multiple parallel rows, extruded towards said interior space, forming multiple rows of sample wells of said multiple gels;
a gel solution, composed of water, gelling material, and buffering chemicals at a desired concentration, held by said container, occupying said interior space, contacting said plurality of teeth, being capable of solidifying as a gel block;
a guiding means, having a guiding line for cutting path control and a marker for position control, determining cutting point and cutting angle of said gel block; and
a slicing means, having a cutting edge compatible to said gel block, guided by said guiding means, slicing said gel block to generate multiple gels;
(b) introducing said gelling solution into said container and waiting for formation of said gel block via solidification of gelling solution;
(c) positioning said guiding means against said gel block; and
(d) slicing said gel block, guided by guiding means, to generate each piece of said multiple gels.

4. The method as claimed in claim 3 wherein said solidification is a result of temperature reduction of said gelling solution.
